(19) United States
(12) Patent Application Publication
(10) Pub. No.: US 2016/0217641 A1
(43) Pub. Date: Jul. 28, 2016

(54) IN-STADIUM MOBILE GAMES

(71) Applicant: Topline Game Labs, LLC, Los Angeles, CA (US)

(72) Inventors: David Geller, Los Angeles, CA (US); Edwin Pankau, Los Angeles, CA (US); Joshua Small, Los Angeles, CA (US); Christopher Shattuck, Pasadena, CA (US); Katherine Freshwater, Beverly Hills, CA (US)

(73) Assignee: Topline Game Labs, LLC, Los Angeles, CA (US)

(21) Appl. No.: 15/002,807

(22) Filed: Jan. 21, 2016

Related U.S. Application Data
(60) Provisional application No. 62/106,487, filed on Jan. 22, 2015.

(51) Int. Cl. G07F 17/32

(52) U.S. Cl. CPC G07F 17/323; G07F 17/3227; G07F 17/3288; G07F 17/3244; G07F 17/3218; G07F 17/3241

(57) ABSTRACT

A system for in-stadium mobile games includes a server computer for collecting and distributing sporting-event data; and a client computer in communication with the server computer over a network. The client computer includes a computer memory for storing software instructions; and a computer processor for executing the software instructions. The software instructions perform the steps of (1) receiving, from a user via an input device, a selection of a plurality of athletes competing in a sporting event; (2) receiving, from the server computer, information regarding performance of the selection of the plurality of athletes; (3) during or upon completion of the sporting event, computing a score of the user based on the selection and the performance; and (4) indicating that the score of the user surpasses at least one other score of another user and that the user be awarded a prize.

### CROSS-REFERENCE TO RELATED APPLICATIONS

This application claims priority to and the benefit of U.S. Provisional Patent Application Ser. No. 62/106,487, filed on Jan. 22, 2015, which is hereby incorporated herein by reference in its entirety.

### BACKGROUND

### Technical Field

Described herein are various embodiments of methods and systems for games of skill based on professional or amateur sporting events played while the events are occurring.

### SUMMARY OF THE INVENTION

In one aspect, a system for in-stadium mobile games includes a server computer for collecting and distributing sporting-event data; a client computer in communication with the server computer over a network, the client computer including a computer memory for storing software instructions; and a computer processor for executing the software instructions, the software instructions performing the steps of (1) receiving, from a user via an input device, a selection of a plurality of athletes competing in a sporting event, (2) receiving, from the server computer, information regarding performance of the selection of the plurality of athletes, (3) during or upon completion of the sporting event, computing a score of the user based on the selection and the performance, and (4) indicating that the score of the user surpasses at least one other score of another user and that the user be awarded a prize.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 shows an example embodiment of a system for in-stadium mobile games.

FIGS. 2A-2F show example screenshots and wireframe for unlocking and playing a mobile game.

FIGS. 3A-3B show example screenshots and wireframe for managing a mobile game.

FIGS. 4A-4C show example screenshots and wireframe for claiming a prize from a mobile game.

### DETAILED DESCRIPTION

Reference will now be made in detail to example embodiments of the present invention, examples of which are illustrated in the accompanying drawings.

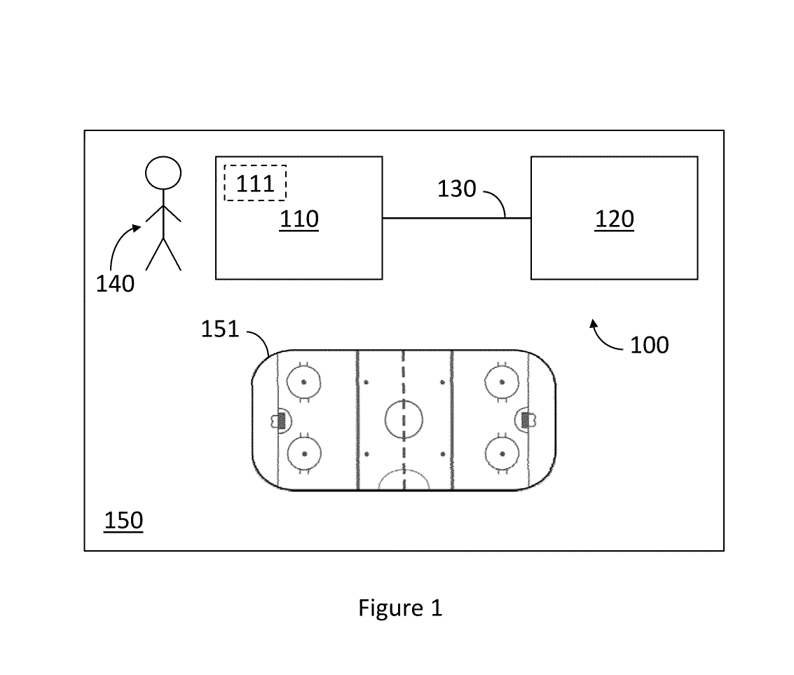

FIG. 1 shows an example system 100 for in-stadium mobile games. According to example embodiments, games of skill based on professional or amateur sporting events may be played while the events are occurring. The skill games may be played while a player 140 is in attendance at the event 151 (e.g., at stadium 150) or while the player is viewing the event remotely (e.g., on television or via Internet cast). The game may be presented to the player via a software application running on a device 110, such as a mobile device, tablet computer, or laptop/desktop computer or via a thin-client application (such as a web page viewed on a web browser) executing on the device.

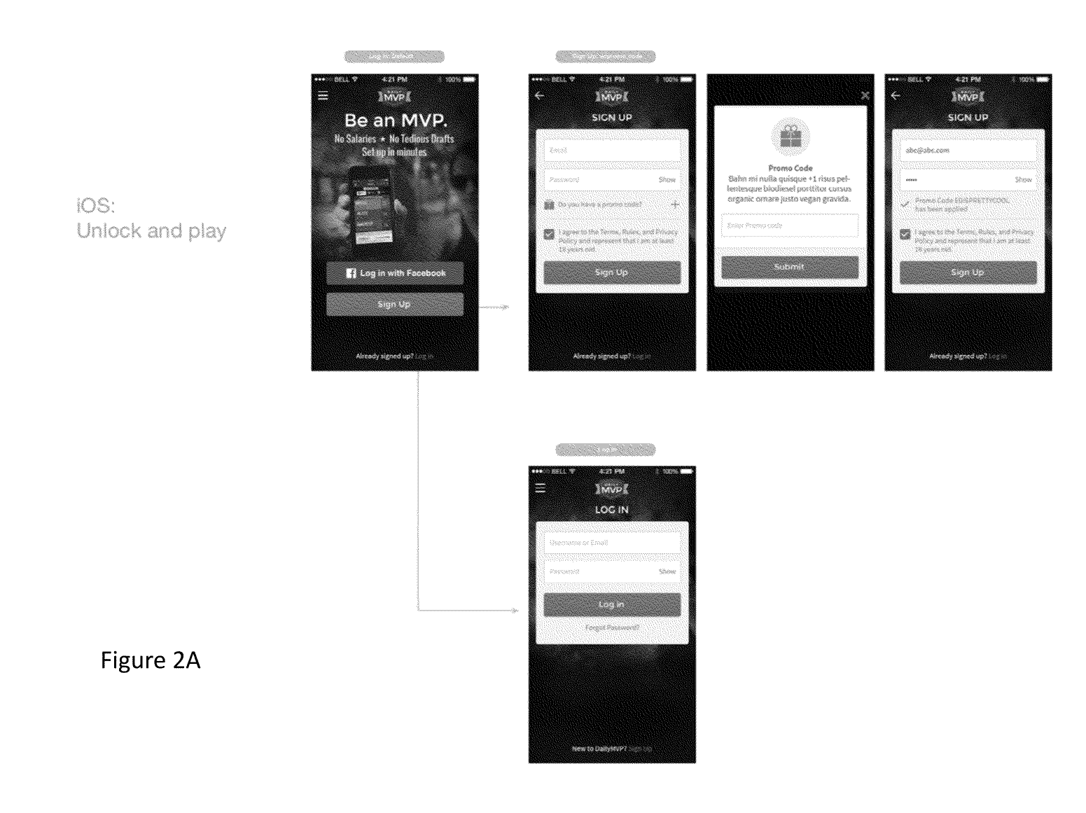

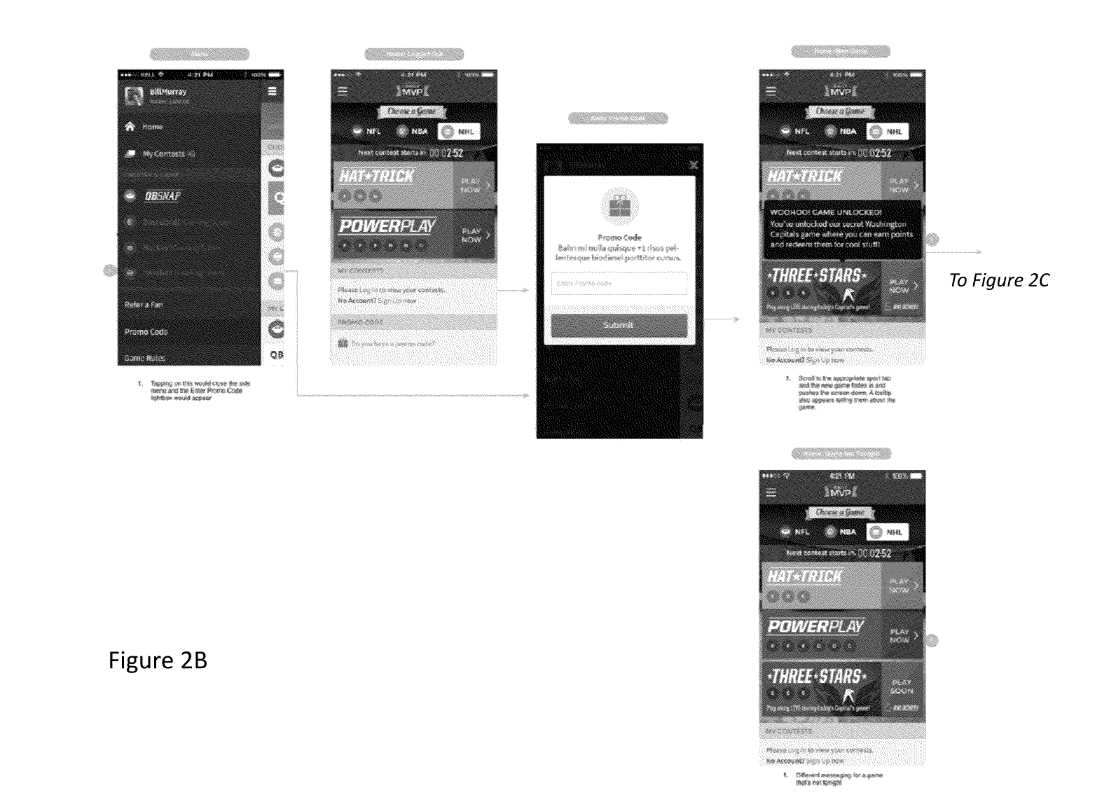

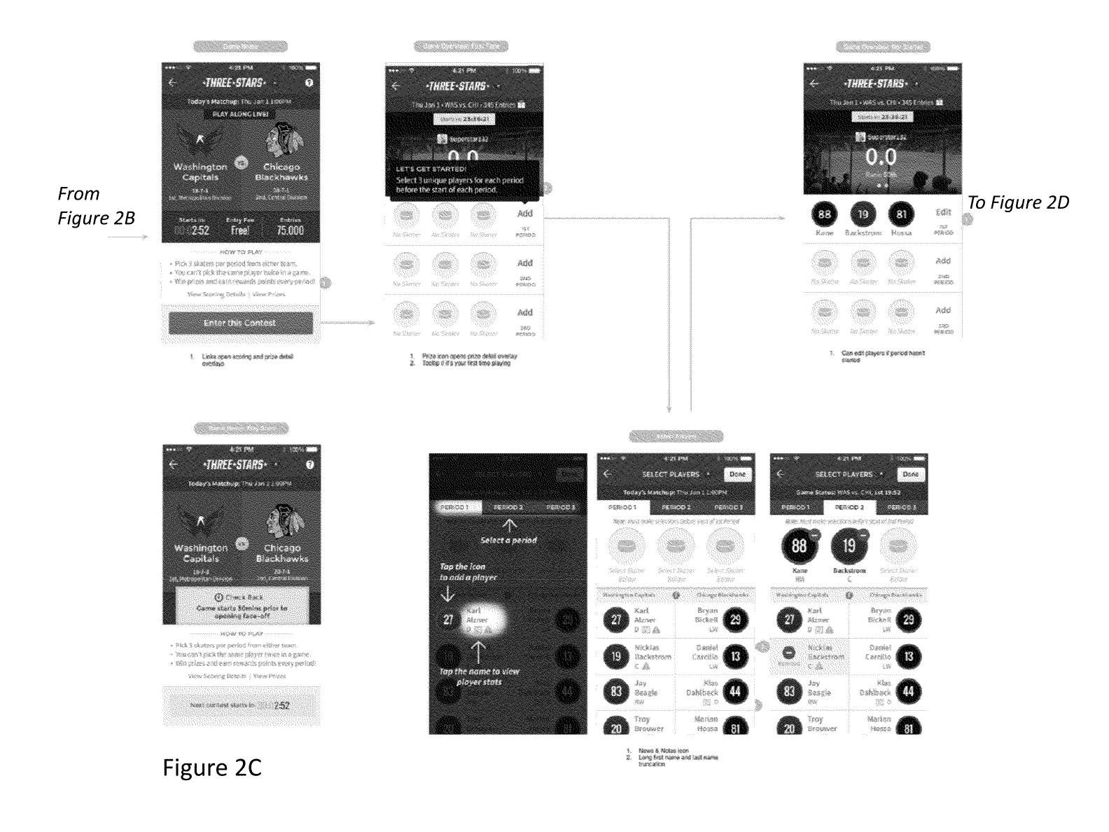

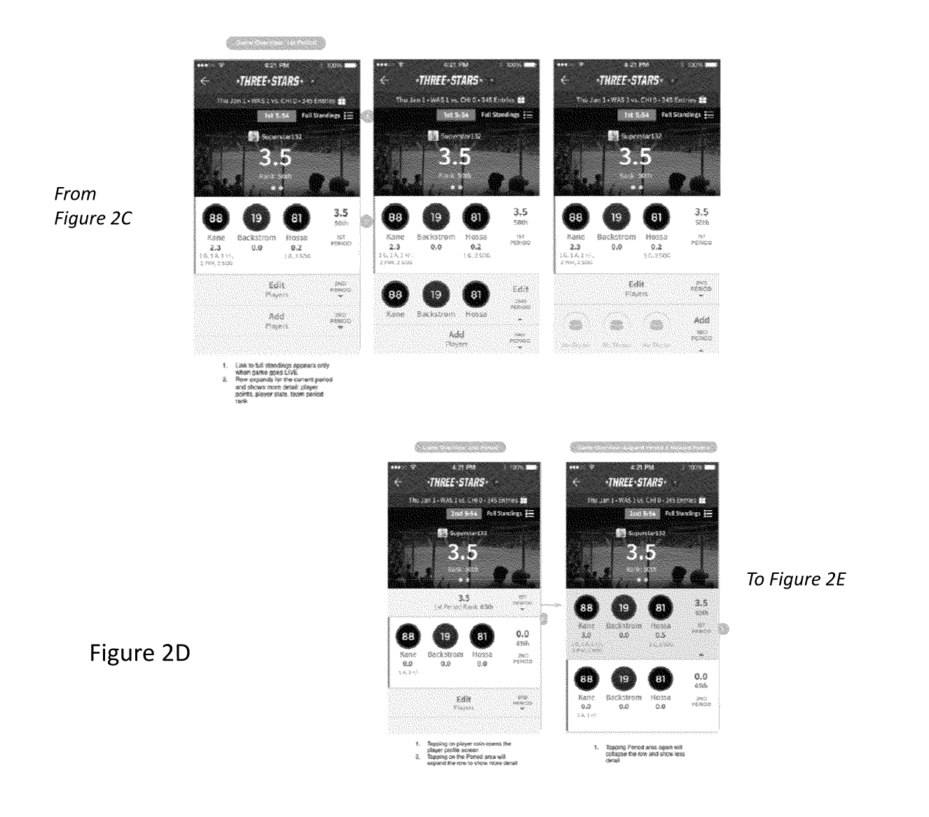

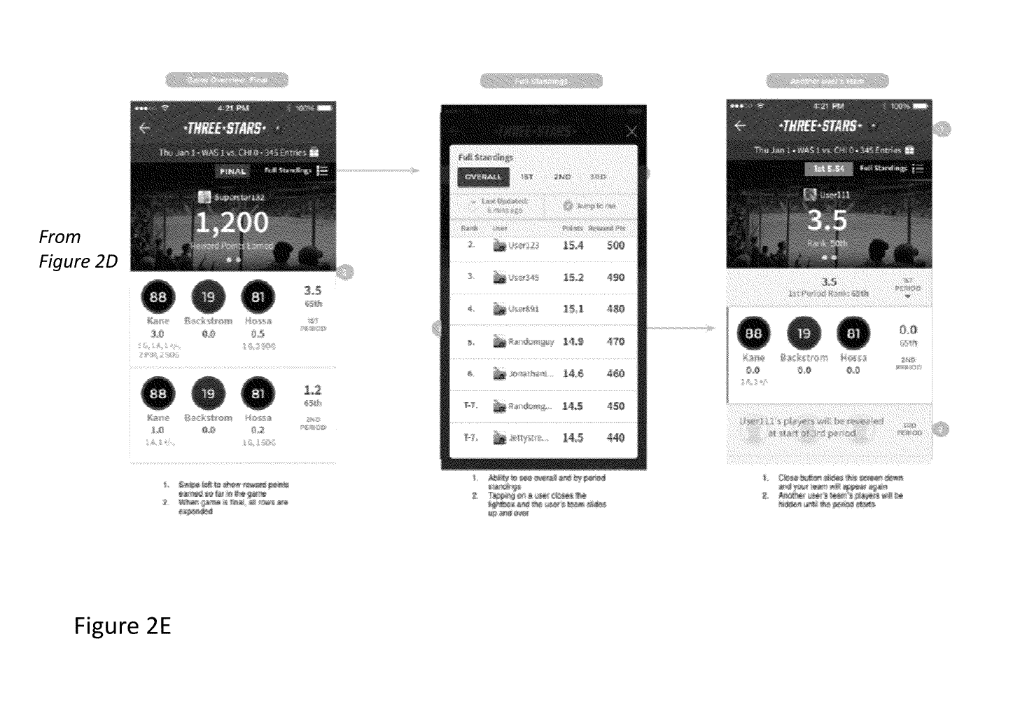

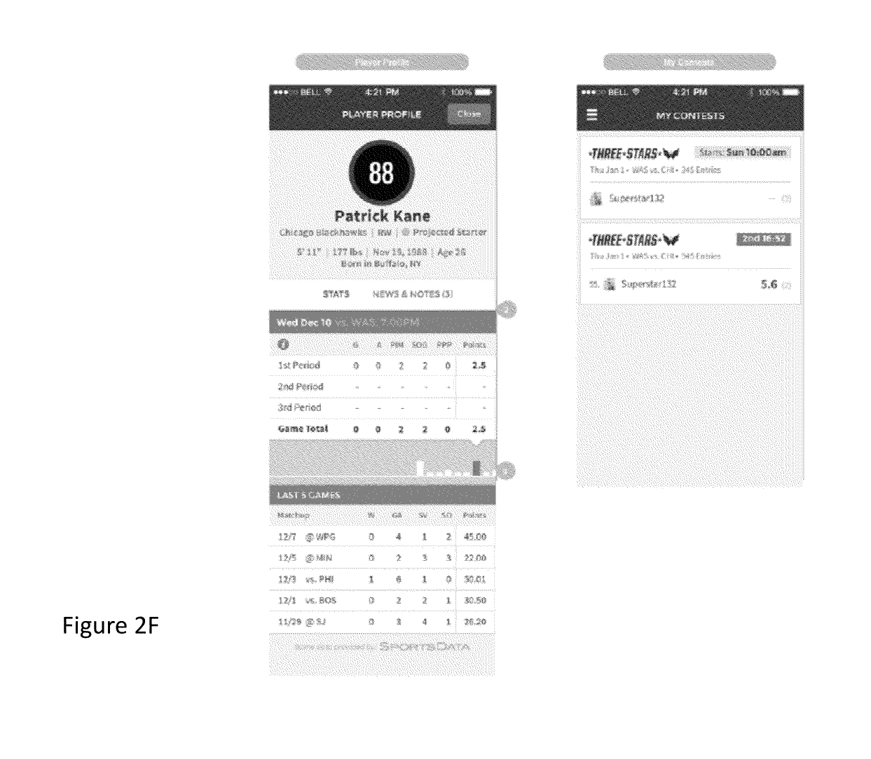

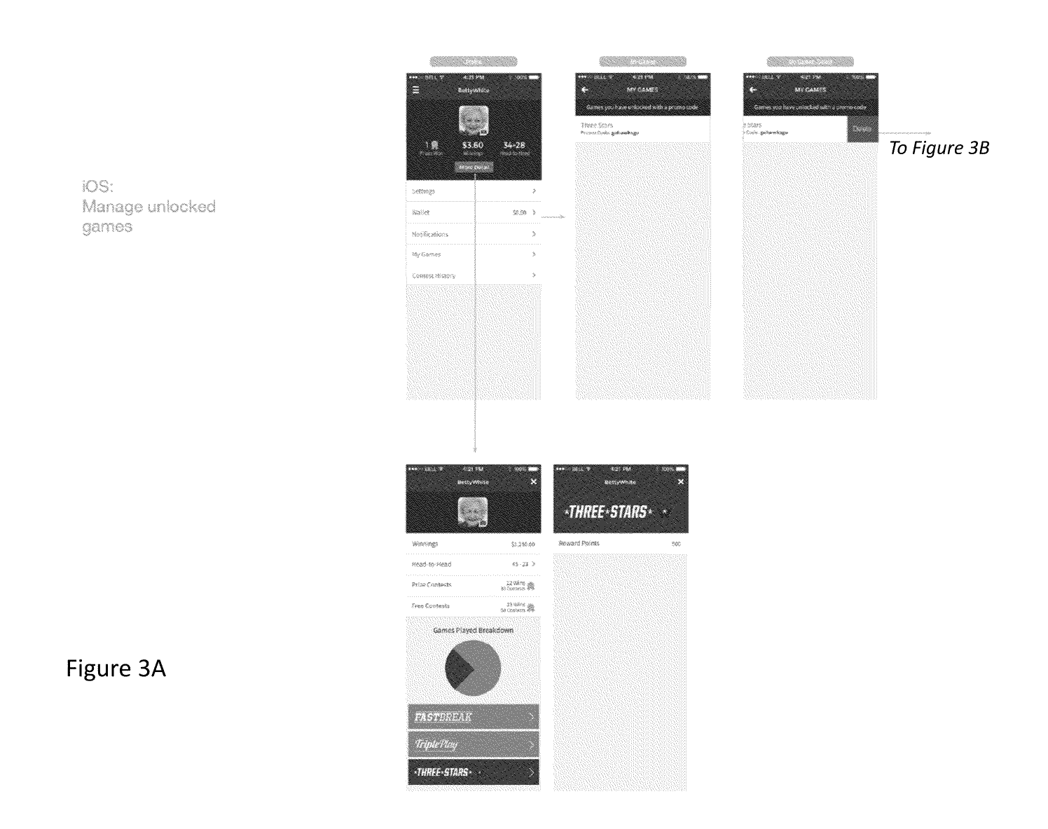

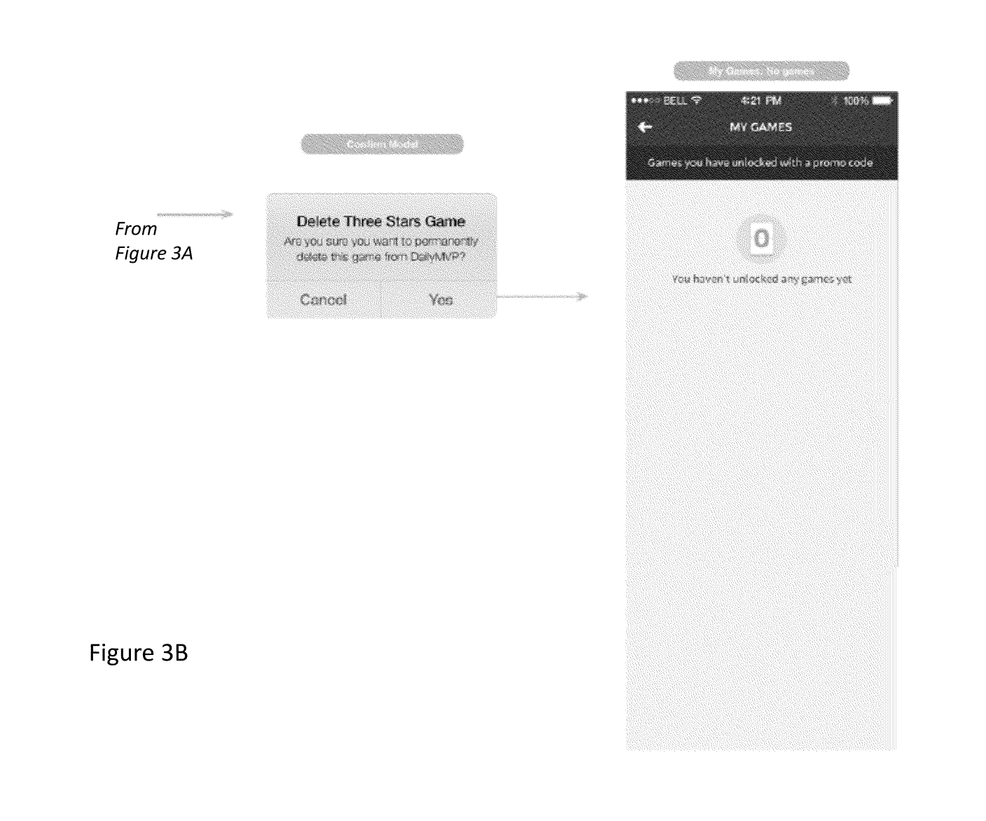

As shown by example in FIGS. 2A-2F, in one embodiment, a player 140 selects a sporting event and number of athletes performing in said event using input device 111. The player thereafter earns points or credits toward a score based on the performance of the selected athletes. The game application may receive real-time or periodic updates comprising information about the performance of the athletes over a network 130 from a remote server 120 and compute the player's score accordingly; the application may display to the player a current player score on a display of the device. One or more players having the most points at the end of the event is declared the winner and receives a prize.

Any number of statistics or criteria surrounding the performance of the athlete may be used to compute the player's score, and the criteria may vary across different sports. For example, if the sport is ice hockey, the player may earn points if a selected athlete scores a goal, assist, or shot on goal; if the sport is baseball, the player may earn points if a selected athlete scores a run, a run batted in, or a walk. Any sport and any system of scoring is within the scope of the present invention; a sample scoring system for ice hockey, however, appears below.

| Statistic | Description | Point Value | |
|---|---|---|---|
| G | Goal | 3 | pts |
| A | Assist | 2 | pts |
| +/− | Plus-minus | 1 | pt |
| PIM | Penalty Minute | 0.2 | pt |
| SOG | Shot on Goal | 0.5 | pt |
| PPP | Power Play Point | 0.3 | pt |

Players may compete against any number of other players. For example, each player may compete against every other player who selects the same sporting event. In other embodiments, a player may compete against only a subset of the total number of other players; the subset may be selected based on geographic location (e.g., present at the actual event), size of prizes/rewards, or may be randomly allocated to different “bins” of players.

In one embodiment, a player selects a number of competing athletes before the sporting event begins and does not re-select athletes again during the event. In other embodiments, however, players may add, change or delete athletes from their selection during the sporting event; the changes may be permitted during breaks in the event, such as after completion of a period, quarter, or half, or during time-outs. In one embodiment, players must change their entire selection during each break (e.g., after completion of each period and before the beginning of the next period) and cannot select the same athlete twice.

In one embodiment, players may not begin selecting athletes until the time of the beginning of the event approaches (e.g., not until 90 minutes before the event begins). They players may select athletes from both teams participating in the event or may be restricted to athletes from only one team.

Any number of athletes may be selected. In one embodiment, three athletes are selected (and/or re-selected) during the game. In other embodiments, players may select a variable number of athletes (e.g., one player may select three and another four); in this embodiment, player's scores may be compared against each other by, for example, computing a highest average points-per-selected-athlete.

The game application may further permit a player to make predictions and selections based on event data not tied to any particular player, such as final score, per-period score, total shots on goal, total yards, etc. For example, the player may be given the chance to predict the total shots on goal by selecting one of the following “bins”: 0-39, 40-49, 50-59, 60-69, or 70+. The number and quantity of the predictions may vary from event to event, or may remain fixed. If the player correctly predicts the outcome, he or she may be awarded a number of bonus points to be added to his or her score. Any number of these bonus predictions may be presented to the player.

The game application may be a set of software instructions written in (for example) C, C++, or JAVA and may be made available on an online store (e.g., APPLE ITUNES or GOOGLE PLAY) or other download site. The player may then install the game application on his or her mobile device or computer via the store or site and execute the application by selecting it. The mobile device or computer includes a computer processor for executing the instructions, a memory for storing the instructions, nonvolatile storage for storing the application, a display for presenting the player with information regarding the game, and a keyboard, mouse, or touchscreen for receiving selections from the user. The mobile device or computer further includes a network connection for communicating with one or more central servers that track the points scored by the players.

In various embodiments, the player selects an event by selecting the event from a presented list or menu, by entering the name of the event, or by entering a code associated with the event. In one embodiment, if the mobile device is aware of its geographic location, the application automatically determines the event. The player may be required to additionally enter his or her name, address, email address, username, password, and/or credit-card information (or otherwise create a user account, which may be stored on the server) prior to or soon after selecting the event and/or athletes. In another embodiment, the player enters his or her personal information only if the player wins a prize. The application may change its interface style based on the event or event type, such as by presenting the competing teams' logo or colors.

The player may be allowed to enter the game for free or may be charged an entry fee. Paying the entry fee may allow the player to, for example, opt out of in-application advertising and/or be eligible for prizes of greater value.

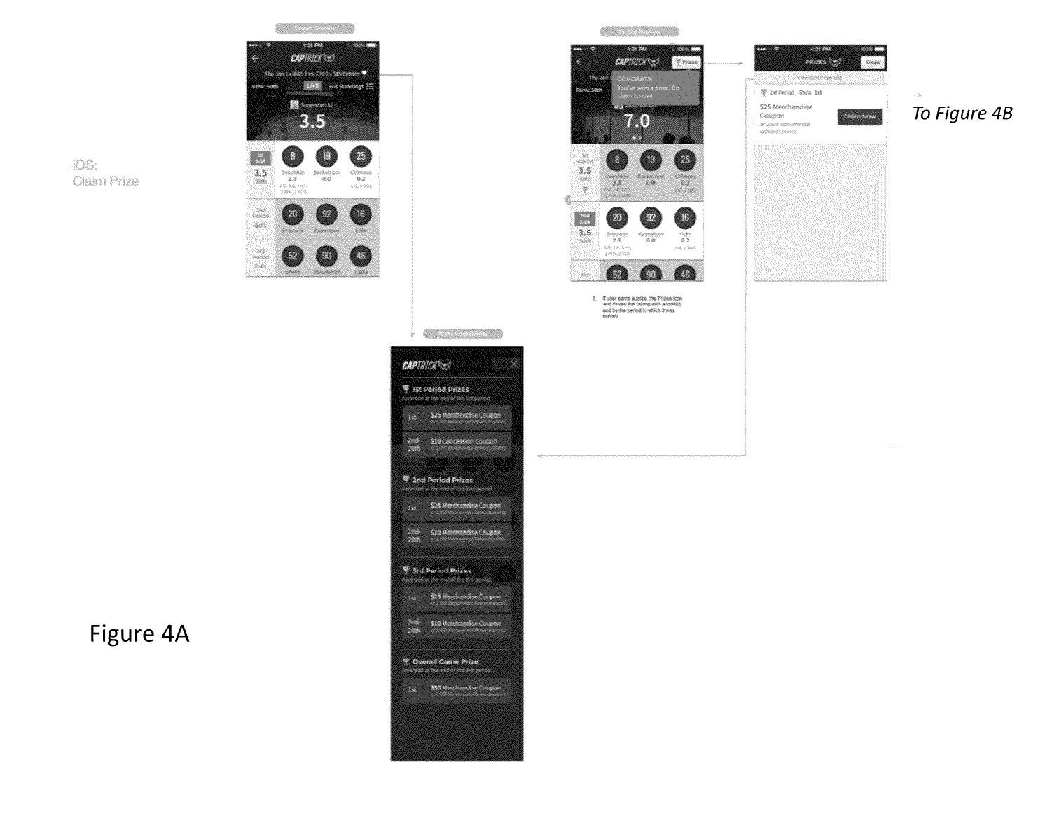

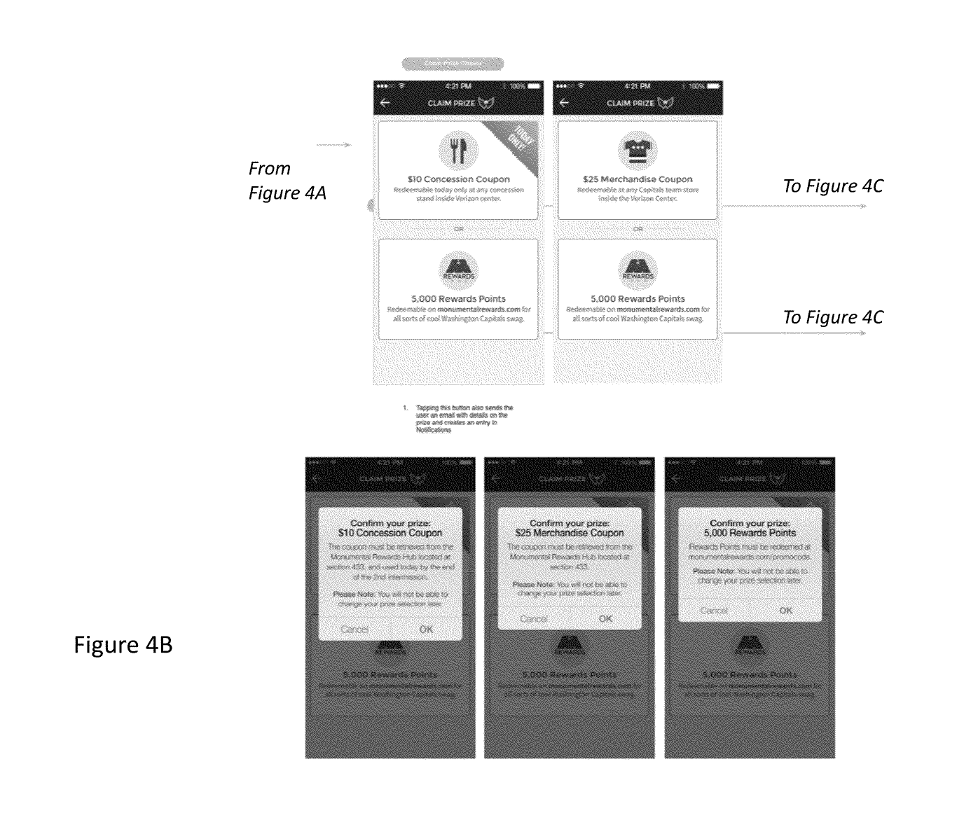

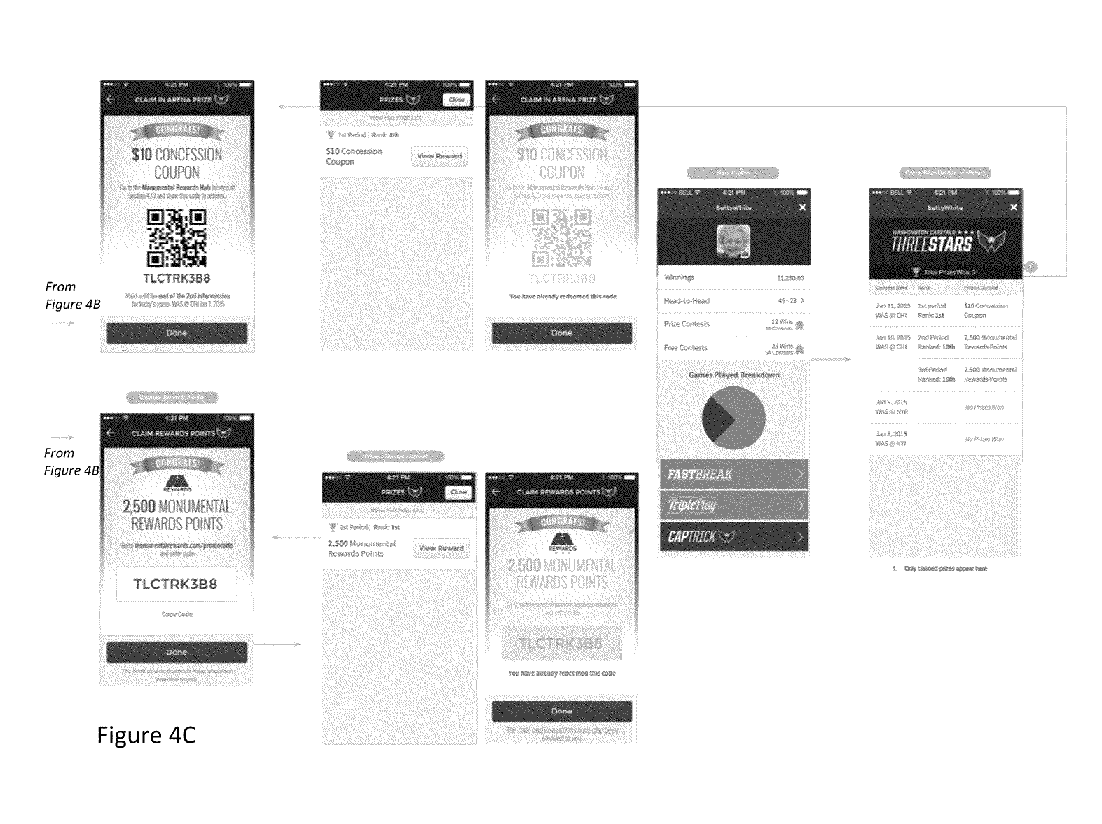

As shown by example in FIGS. 4A-4C, any number or type of prizes may be awarded. Example prizes include in-stadium prizes, overall prizes, and rewards points. Only players at the event may be eligible for some or all of the prizes. Prizes may be awarded after completion of the event and/or after completion of portions of the event (e.g., periods, quarters, or halves). Further prizes may be awarded based on how many times the player has competed in events and/or how well the player has scored in past events; for example, rewards points may be awarded to the player after participation in five, ten, or twenty events or after accumulation of ten, twenty, or fifty total points from past events.

The application may notify the player when input is requested or required. For example, a notification may be sent when the event is open for selection, after a period, half, or quarter is completed and new selections are required, when a bonus selection is available, and if the player has won a prize. The notifications may be sounds, vibrations, in-application messages, or SMS/MMS messages.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A system for in-stadium mobile games, the system comprising:
a server computer for collecting and distributing sporting-event data; and
a client computer in communication with the server computer over a network, the client computer including:
i. a computer memory for storing software instructions; and
ii. a computer processor for executing the software instructions, the software instructions performing the steps of:
1. receiving, from a user via an input device, a selection of a plurality of athletes competing in a sporting event;
2. receiving, from the server computer, information regarding performance of the selection of the plurality of athletes;
3. during or upon completion of the sporting event, computing a score of the user based on the selection and the performance; and
4. indicating that the score of the user surpasses at least one other score of another user and that the user be awarded a prize.

2. The system of claim 1, wherein the user and the client computer are present in-person at the sporting event.

3. The system of claim 1, wherein the prize is delivered in-person at the sporting event.

4. The system of claim 1, wherein the client computer is a mobile device.

5. The system of claim 1, wherein the sporting event is an ice hockey game, a football game, a basketball game, or a baseball game.

6. The system of claim 1, wherein the software instructions perform the further step of granting rewards points to the user based on a number of events previously attended by the user or a score value previously accrued by the user.

7. The system of claim 1, wherein the software instructions perform the further step of receiving a code from the user identifying the sporting event.

8. The system of claim 1, wherein the score of the user is determined upon completion of a period, quarter, or half of the sporting event.
